(19) United States
(12) Patent Application Publication
(10) Pub. No.: US 2026/0141219 A1
(43) Pub. Date: May 21, 2026

(54) NON-TRANSITORY COMPUTER-READABLE RECORDING MEDIUM, MACHINE LEARNING METHOD, AND INFORMATION PROCESSING APPARATUS

(71) Applicant: Fujitsu Limited, Kawasaki-shi (JP)

(72) Inventor: Yuuji KANAZAWA, Setagaya (JP)

(73) Assignee: Fujitsu Limited, Kawasaki-shi (JP)

(21) Appl. No.: 19/447,093

(22) Filed: Jan. 13, 2026

Related U.S. Application Data
(63) Continuation of application No. PCT/JP2023/028172, filed on Aug. 1, 2023.

(51) Int. Cl. G06N 3/0455; G06N 3/08

(52) U.S. Cl. CPC G06N 3/0455; G06N 3/08

(57) ABSTRACT

A non-transitory computer-readable recording medium has stored therein a machine learning program that causes a computer to execute a process including specifying an autoencoder in which a difference between input data and output data is equal to or greater than a predetermined standard from among autoencoders that are included in a data generation model, in a case where a training is performed on the data generation model that includes a plurality of autoencoders that are disposed in a first stage and one or more autoencoders that are disposed in an N^{th} stage and performing the training on the data generation model by using the specified autoencoder, and the autoencoder that receives, as the input data, the output data that has been output from the specified autoencoder as a target for the training.

### CROSS-REFERENCE TO RELATED APPLICATION

This application is a continuation of International Application No. PCT/JP2023/028172, filed on August 1, 2023, the entire contents of which are incorporated herein by reference.

### FIELD

The embodiment discussed herein is related to a machine learning program, and the like.

### BACKGROUND

An autoencoder is used for various tasks of a dimensional reduction in data, a feature extraction, and the like. FIG. 14 is a diagram for explaining an autoencoder.

As illustrated in FIG. 14, for example, an autoencoder 10 includes an encoder 10a and a decoder 10b. The encoder 10a generates a low-dimensional feature representation 12 by encoding input data 11. The decoder 10b generates reconstruction data 13 on the basis of the feature representation 12 that has been obtained by the encoder 10a.

The autoencoder 10 is trained such that an error between the input data 11 and the reconstruction data 13 becomes small. With this process, the autoencoder 10 extracts a feature of data, and generates similar data.

For example, if it is assumed that the input data 11 is an image (RGB image) constituted of pn pixels, the dimension of the input data 11 becomes an N dimension (N = pn × 3). Among the pieces of data represented in an N-dimensional space, only a small portion of the data becomes meaningful data as the image. Here, when the input data 11 is input to the encoder 10a and is converted to the feature representation 12, it is possible to represent the image in an n-dimensional space that is far smaller than the original N-dimensional space. The n-dimensional feature representation 12 is data obtained by abstracting the input data 11, and is able to use for another task, such as classification, by using the feature representation 12.

Moreover, it is able to use the autoencoder 10 as a generation model by guaranteeing continuity correspondence between the space of the input data and the space of the encoded result. For example, in this generation model, meaningful data in the N-dimensional space is generated by inputting a value to the encoded result. A conventional technology, such as a variational autoencoder (VAE), has been proposed as a generation model with such an autoencoder type.

Patent Document 1: International Publication Pamphlet No. WO 2021/059348

### SUMMARY

According to an aspect of an embodiment, a non-transitory computer-readable recording medium has stored therein a machine learning program that causes a computer to execute a process including specifying an autoencoder in which a difference between input data and output data is equal to or greater than a predetermined standard from among autoencoders that are included in a data generation model, in a case where a training is performed on the data generation model that includes a plurality of autoencoders that are disposed in a first stage and that respectively uses a plurality of pieces of divided data obtained by dividing original input data as respective pieces of input data, and one or more autoencoders that are disposed in an N^{th} stage and that respectively use output data that has been output from each of two or more autoencoders that are disposed in an N-1^{th} from among the plurality of autoencoders that are disposed in the N-1^{th} stage (N is an integer equal to or greater than two) as input data and performing the training on the data generation model by using the specified autoencoder, and the autoencoder that receives, as the input data, the output data that has been output from the specified autoencoder as a target for the training.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an autoencoder according to the present embodiment;

FIG. 2 is a diagram for explaining a process of inputting an input image to autoencoder cells;

FIG. 3 is a diagram for explaining an initial training performed on a cell;

FIG. 4 is a diagram illustrating one example of a data structure of statistic information;

FIG. 5 is a diagram illustrating one example of a data structure of a management table;

FIG. 6 is a diagram illustrating one example of a data structure of a training data table;

FIG. 7 is a diagram illustrating one example of a data structure of a retraining target management table;

FIG. 8 is a diagram for explaining a cell targeted for a retraining;

FIG. 9 is a diagram for explaining a process of generating data for performing the retraining;

FIG. 10 is a functional block diagram illustrating a configuration of an information processing apparatus according to the present embodiment;

FIG. 11 is a flowchart illustrating the flow of a process performed in the information processing apparatus according to the present embodiment;

FIG. 12 is a flowchart illustrating the flow of a process of a generation process;

FIG. 13 is a diagram illustrating one example of a hardware configuration of a computer that implements the same function as that performed by the information processing apparatus according to the present embodiment; and

FIG. 14 is a diagram for explaining an autoencoder.

### DESCRIPTION OF EMBODIMENTS

In the conventional technology, in a case where input data including an untrained pattern appears related to the autoencoder 10, there is a problem in that a retraining of the autoencoder 10 is performed, but the cost needed for the retraining is high.

For example, in a case where the autoencoder 10 is retrained, both of already-existing input data that has been used for the training performed until last time and input data that includes the untrained pattern are used. Regarding the already-existing input data, the already-existing input data stored in an own device is used, or the already-existing input data is acquired again from another device or the like. If the already-existing input data is stored in the own device, a storage device is continuously under pressure. Furthermore, in a case where the already-existing input data is acquired again, the already-existing input data may be stored in the other device, which is a prerequisite, and the storage device included in the other device is accordingly under pressure.

Moreover, in a case where only the input data including the untrained pattern is used without using the already-existing input data, it is no longer be able to process the already-existing input data that has been able to be handled (catastrophic forgetting).

Furthermore, there is also a conventional technology for encoding input data by combining a plurality of autoencoders, extracting a feature representation, and generating reconstruction data from the feature representation. With this type of conventional technology, all of the autoencoders correspond to the targets to be retrained, the time needed to complete the retraining is long, and electrical power consumption is accordingly high.

Preferred embodiments of the present invention will be explained with reference to accompanying drawings. Furthermore, the present invention is not limited to these embodiments.

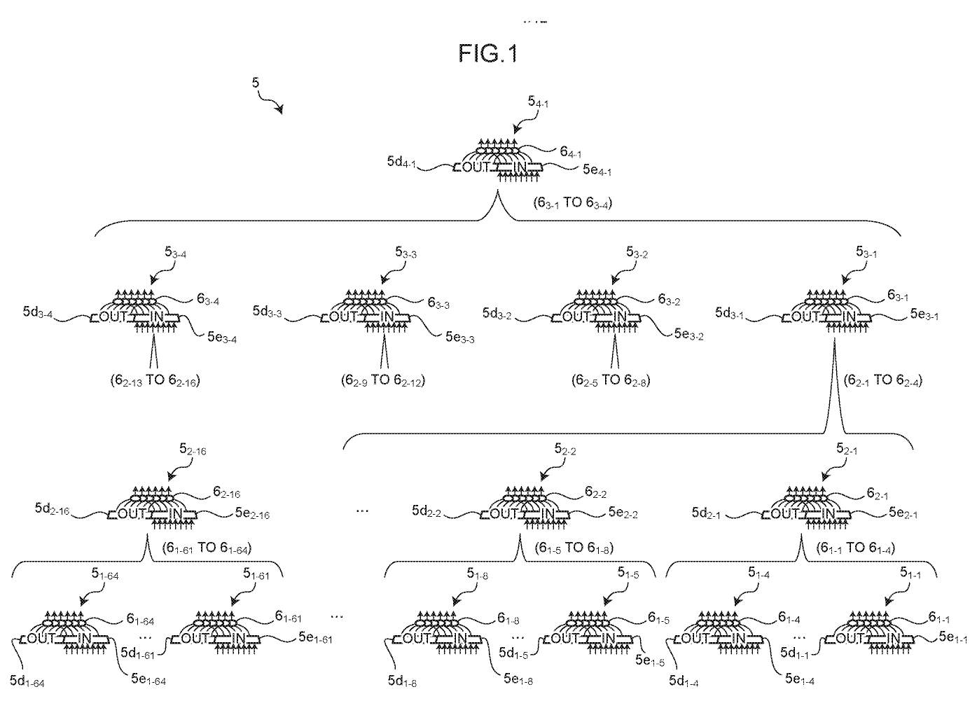

One example of an autoencoder according to the present embodiment will be described. FIG. 1 is a diagram illustrating one example of the autoencoder according to the present embodiment. An autoencoder 5 includes a plurality of autoencoder cells in each stage. In the explanation below, the autoencoder cell is simply referred to as a "cell". In the present embodiment, it is assumed that an information processing apparatus performs various kinds of processes related to the autoencoder 5.

The information processing apparatus according to the present embodiment inputs an encoded result of a cell that is disposed in the previous stage into the cell that is disposed in the next stage included in the autoencoder 5. In a case where all of the inputs are statistically biased, the encoded results of two or more cells have some sort of correlation. For example, one example of this correlation is a relationship in which, if an encoded result of the first cell is X, an encoded result of the second cell is determined to be Y, or the like. Another example of this correlation is that, in a case where the input data is an image, if a straight line is present in a certain area, an extension of that straight line is often present in an adjacent area. The information processing apparatus uses the autoencoder 5 having a plurality of cells in order to repeatedly perform a process of finding out a statistical bias of the encoded result in the previous stage, and to further perform a process of compressing the encoded result.

For example, the autoencoder 5 includes cells 5₁₋₁ to 5₁₋₆₄ that are disposed in a first stage, cells 5₂₋₁ to 5₂₋₁₆ that are disposed in a second stage, cells 5₃₋₁ to 5₃₋₄ that are disposed in a third stage, and a cell 5₄₋₁ that is disposed in a fourth stage. In the example illustrated in FIG. 1, an explanation will be given by using a plurality of cells constituted of four stages, but the example is not limited to this example. Furthermore, as a convenience, an illustration of some of cells included in the autoencoder 5 will be omitted.

First, each of the cells disposed in the first stage included in the autoencoder 5 will be described. The cell 5₁₋₁ includes an encoder 5e₁₋₁ and a decoder 5d₁₋₁. As a result of the information processing apparatus inputting input data to the encoder 5e₁₋₁ that is included in the cell ₁₋₁, a feature representation 6₁₋₁ is generated.

Although not illustrated, each of cell 5₁₋₂ to 5₁₋₃ includes an encoder and a decoder. As a result of the information processing apparatus inputting input data to each of the encoders included in cells ₁₋₂ to 5₁₋₃, feature representations 6₁₋₂ to 6₁₋₃ are generated. The cell 5₁₋₄ includes an encoder 5e₁₋₄ and a decoder 5d₁₋₄. As a result of the information processing apparatus inputting input data to the encoder 5e₁₋₄ included in the cell 5₁₋₄, a feature representation 6₁₋₄ is generated.

The information processing apparatus inputs the feature representations 6₁₋₁ to 6₁₋₄ to the encoder 5e₁₋₁ included in the cell 5₂₋₁ that is disposed in the second stage.

The cell 5₁₋₅ includes an encoder 5e₁₋₅ and a decoder 5d₁₋₅. As a result of the information processing apparatus inputting input data to the encoder 5e₁₋₅ included in the cell ₁₋₅, a feature representation 6₁₋₅ is generated.

Although not illustrated, each of the cell 5₁₋₆ and 5₁₋₇ includes an encoder and a decoder. As a result of the information processing apparatus inputting input data to the encoder included in each of the cells ₁₋₆ and the 5₁₋₇, feature representations 6₁₋₆ and 6₁₋₇ are generated. The cell 5₁₋₈ includes an encoder 5e₁₋₈ and a decoder 5d₁₋₈. As a result of the information processing apparatus inputting input data to the encoder 5e₁₋₈ included in the cell ₁₋₈, a feature representation 6₁₋₈ is generated.

The information processing apparatus inputs the feature representations 6₁₋₅ to 6₁₋₈ to an encoder 5e₂₋₂ included in the cell 5₂₋₂ that is disposed in the second stage.

An illustration of the cells 5₁₋₉ to 5₁₋₆₀ disposed in the first stage will be omitted. Each of the cells 5₁₋₉ to 5₁₋₆₀ includes, similarly to the other cells, an encoder and a decoder. As a result of the information processing apparatus inputting input data to each of the cells 5₁₋₉ to 5₁₋₆₀, feature representations 6₁₋₉ to 6₁₋₆₀ are generated. The information processing apparatus inputs the generated feature representations to the respective encoders included in the respective cells 5₂₋₃ to 5₂₋₁₅ that are disposed in the second stage. An illustration of the cells 5₂₋₃ to 5₂₋₁₅ in the second stage will be omitted.

The cell 5₁₋₆₁ includes an encoder 5e₁₋₆₁ and a decoder 5d₁₋₆₁. As a result of the information processing apparatus inputting input data to the encoder 5e₁₋₆₁ included in the cell 5₁₋₆₁, a feature representation 6₁₋₆₁ is generated.

Although not illustrated, each of the cell 5₁₋₆₂ and 5₁₋₆₃ includes an encoder and the decoder. As a result of the information processing apparatus inputting input data to the encoders included in the cells 5₁₋₆₂ and 5₁₋₆₃, feature representations 6₁₋₆₃ to 6₁₋₆₃ are generated. The cell 5₁₋₆₄ includes an encoder 5e₁₋₆₄ and a decoder 5d₁₋₆₄. As a result of the information processing apparatus inputting input data to the encoder 5e₁₋₆₄ included in the cell 5₁₋₆₄, a feature representation 6₁₋₆₄ is generated.

The information processing apparatus inputs the feature representations 6₁₋₆₁ to 6₁₋₆₄ to the encoder 5e₁₋₁₆ included in the cell 5₂₋₁₆ that is disposed in the second stage.

Subsequently, each of the cells included in the second stage included in the autoencoder 5 will be described. The cell 5₂₋₁ includes an encoder 5e₂₋₁ and a decoder 5d₂₋₁. As a result of the information processing apparatus inputting the pieces of input data (the feature representations 6₁₋₁ to 6₁₋₄) to the encoder 5e₂₋₁ included in the cell ₂₋₁, a feature representation 6₂₋₁ is generated.

The cell 5₂₋₂ includes the encoder 5e₂₋₂ and a decoder 5d₂₋₂. As a result of the information processing apparatus inputting the pieces of input data (the feature representations 6₁₋₅ to 6₁₋₈) to the encoder 5e₂₋₂ included in the cell ₂₋₂, a feature representation 6₂₋₂ is generated.

An illustration of the cells 5₂₋₃ to 5₂₋₁₅ that are disposed in the second stage will be omitted. Each of the cells 5₂₋₃ to 5₂₋₁₅ includes, similarly to the other cells, and encoder and a decoder. As a result of the information processing apparatus inputting pieces of input data (feature representations 6₁₋₉ to 6₁₋₆₀) to the cell 5₂₋₃ to 5₂₋₁₅, feature representations 6₂₋₃ to 6₂₋₁₅ are generated.

The cell 5₂₋₁₆ includes an encoder 5e₂₋₁₆ and a decoder 5d₂₋₁₆. As a result of the information processing apparatus inputting pieces of input data (the feature representations 6₁₋₆₁ to 6₁₋₆₄) to the encoder 5e₂₋₁₆ included in the cell 5₂₋₁₆, a feature representation 6₂₋₁₆ is generated.

Subsequently, each of the cells disposed in the third stage included in the autoencoder 5 will be described. The cell 5₃₋₁ includes an encoder 5e₃₋₁ and a decoder 5d₃₋₁. As a result of the information processing apparatus inputting pieces of input data (the feature representations 6₂₋₁ to 6₂₋₄) to the encoder 5e₃₋₁ included in the cell ₃₋₁, a feature representation 6₃₋₁ is generated.

The cell 5₃₋₂ includes an encoder 5e₃₋₂ and a decoder 5d₃₋₂. As a result of the information processing apparatus inputting pieces of input data (feature representations 6₂₋₅ to 6₂₋₈) to the encoder 5e₃₋₂ included in the cell ₃₋₂, a feature representation 6₃₋₂ is generated.

The cell 5₃₋₃ includes an encoder 5e₃₋₃ and a decoder 5d₃₋₃. As a result of the information processing apparatus inputting pieces of input data (feature representations 6₂₋₉ to 6₂₋₁₂) to the encoder 5e₃₋₃ included in the cell ₃₋₃, a feature representation 6₃₋₃ is generated.

The cell 5₃₋₄ includes an encoder 5e₃₋₄ and a decoder 5d₃₋₄. As a result of the information processing apparatus inputting pieces of input data (feature representations 6₂₋₁₃ to 6₂₋₁₆) to the encoder 5e₃₋₄ included in the cell ₃₋₄, a feature representation 6₃₋₄ is generated.

Subsequently, each of the cells disposed in the fourth stage included in the autoencoder 5 will be described. The cell 5₄₋₁ includes an encoder 5e₄₋₁ and a decoder 5d₄₋₁. As a result of the information processing apparatus inputting pieces of input data (the feature representations 6₃₋₁ to 6₃₋₄) to the encoder 5e₄₋₁ included in the cell ₄₋₁, a feature representation 6₄₋₁ is generated.

As described above, as a result of the information processing apparatus inputting pieces of input data to the cells 5₁₋₁ to 5₁₋₆₄ that are disposed in the first stage included in the autoencoder 5, the feature representation 6₄₋₁ corresponding to a feature value of the input data is obtained.

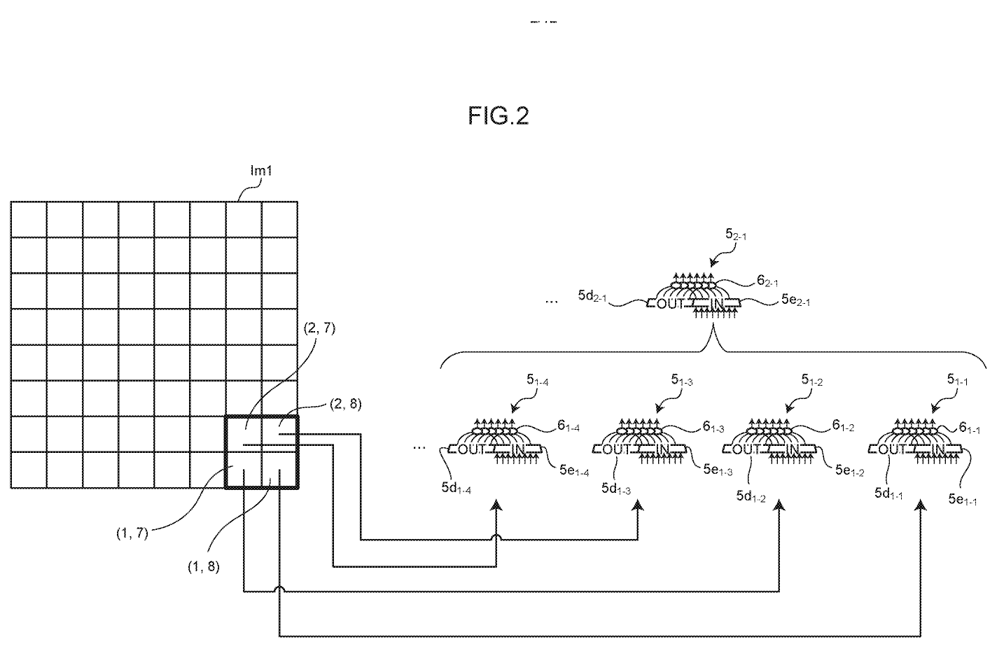

In the following, a case in which an image is input to the autoencoder 5 will be described. FIG. 2 is a diagram for explaining a process of inputting an input image to an autoencoder cell.

The information processing apparatus divides an input image Im1 into a mesh of an 8 × 8 matrix. For example, it is assumed that the bottom stage is a first stage and the leftmost column is a first column, and a mesh at a n^{th} stage and an m^{th} column is denoted by a mesh (n, m). The information processing apparatus divides the input image Im1 into meshes in accordance with the number of cells disposed in the first stage included in the autoencoder 5.

The information processing apparatus inputs each of the meshes (64 meshes) included in the input image Im1 to the respective cells 5₁₋₁ to 5₁₋₆₄ included in the first stage. For example, the information processing apparatus inputs a mesh (1, 8) to the cell 5₁₋₁, and obtains the feature representation 6₁₋₁. The information processing apparatus inputs a mesh (1, 7) to the cell 5₁₋₂, and obtains the feature representation 6₁₋₂. The information processing apparatus inputs a mesh (2, 8) to the cell 5₁₋₃, and obtains a feature representation 6₁₋₃. The information processing apparatus inputs a mesh (2, 7) to the cell 5₁₋₄, and obtains the feature representation 6₁₋₄.

As explained above with reference to FIG. 1, the information processing apparatus obtains the feature representation 6₂₋₁ by inputting the feature representations 6₁₋₁ to 6₁₋₄ to the encoder 5e₂₋₁ included in the cell that is disposed in the second stage. For example, it can be said that the feature representation 6₂₋₁ is a feature value of each of the meshes (1, 7), (1, 8), (2, 7), and (2, 8) included in the input image Im1.

The information processing apparatus also inputs the other meshes included in the input image Im1 to the encoder included in the corresponding cell that is disposed in the first stage. As a result of the information processing apparatus performing these processes, in the end, the feature representation 6₄₋₁ is obtained from the cell 5₄₋₁ that is disposed in the fourth stage included in the autoencoder. The feature representation 6₄₋₁ is a feature value of the input image Im1.

Subsequently, a training performed on the autoencoder 5 by the information processing apparatus according to the present embodiment will be described. First, in the initial training performed on the autoencoder 5, the information processing apparatus sequentially performs a training starting from the cell disposed in the bottom stage. For example, the information processing apparatus performs the initial training on each of the cells 5₁₋₁ to 5₁₋₆₄ that are disposed in the first stage, and then, after having completed the initial training of each of the cells 5₁₋₁ to 5₁₋₆₄, the information processing apparatus proceeds to the initial training to be performed on the cells 5₂₋₁ to 5₂₋₁₆ that are disposed in the second stage. After having completed the initial training of each of the cells 5₂₋₁ to 5₂₋₁₆ that are disposed in the second stage, the information processing apparatus proceeds to the initial training of each of the cells 5₃₋₁ to 5₃₋₄ that are disposed in the third stage. After having completed the initial training of the cells 5₃₋₁ to 5₃₋₄ that are disposed in the third stage, the information processing apparatus proceeds to the initial training of the cell 5₄₋₁ that is disposed in the fourth stage. In a case where the information processing apparatus has completed the initial training of the cell 5₄₋₁ that is disposed in the fourth stage, the information processing apparatus determines that the initial training to be performed on the autoencoder 5 has been completed.

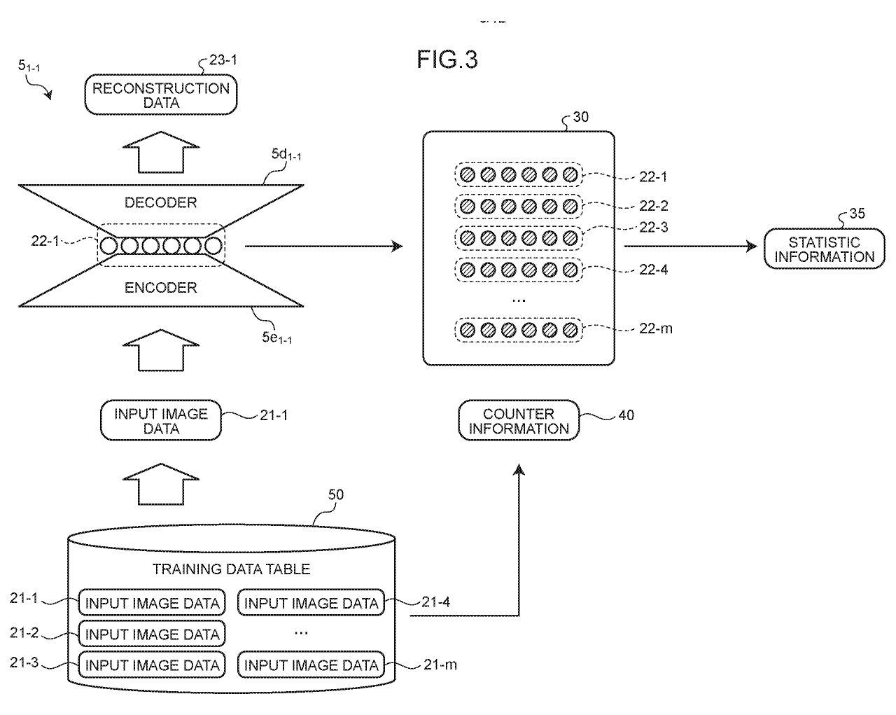

The initial training that is performed on a certain cell by the information processing apparatus will be described. FIG. 3 is a diagram for explaining the initial training performed on a cell. In FIG. 3, as one example, the initial training performed on the cell 5₁₋₁ that is disposed in the first stage will be described.

Regarding the initial training, the information processing apparatus performs a training of the cell 5₁₋₁ disposed in the first stage by using a training data table 50 that is prepared in advance. For example, in the training data table 50, pieces of input image data 21-1, 21-2, 21-3, … , and 21-m are included, where m is a natural number. Moreover, in the present embodiment, a case in which the input image data is used will be described, but an embodiment is also applicable to data other than an image. For example, the input image data is the input image Im1 illustrated in FIG. 2, or the like.

The information processing apparatus acquires the input image data 21-1 from the training data table 50, and divides the input image data 21-1 into meshes of an 8 × 8 matrix. In a case where a training target is the cell 5₁₋₁, the information processing apparatus generates a feature representation 22-1 by inputting the mesh (1, 8) as the input image data 21-1 to the encoder 5e₁₋₁. The information processing apparatus generates reconstruction data 23-1 by inputting the feature representation 22-1 to the decoder 5d₁₋₁. The information processing apparatus trains the encoder 5e₁₋₁ and the decoder 5d₁₋₁ such that an error between the input image data 21-1 and the reconstruction data 23-1 becomes small.

The information processing apparatus also trains the encoder 5e₁₋₁ and the decoder 5d₁₋₁ related to the input image data 21-2, 21-3, … , and 21-m by performing the same process as that described above.

Here, in the course of the process of performing the above described training, the information processing apparatus stores, in a buffer 30, the feature representations 22-1, 22-2, 22-3, … , and 22-m that are generated when the pieces of input image data 21-1, 21-2, 21-3, … , and 21-m are input to the encoder 5e₁₋₁.

The information processing apparatus calculates statistic information 35 on the basis of the feature representations 22-1 to 22-m stored in the buffer 30. For example, the information processing apparatus calculates statistics of an average, a variance, the maximum value, the minimum value, and the like on the basis of the feature representations 22-1 to 22-m as the statistic information 35.

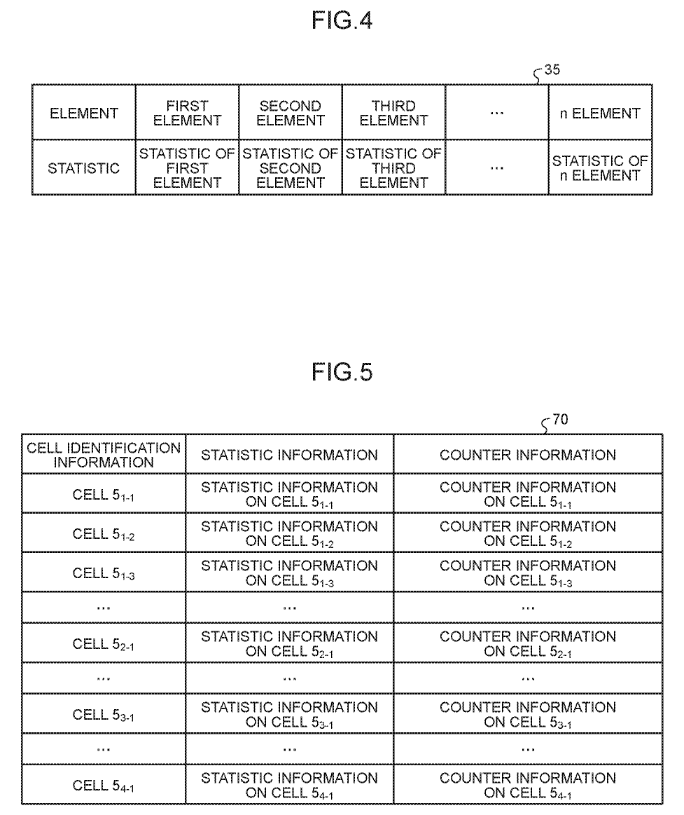

FIG. 4 is a diagram illustrating one example of a data structure of the statistic information. As illustrated in FIG. 4, the statistic information is constituted such that the statistics of the average, the variance, the maximum value, and the minimum value are set for each element corresponding to the associated dimension. For example, if it is assumed that the dimension of the feature representation is an n-dimensional space, the information processing apparatus calculates the statistics of a first element to an n^{th} element, and generates the statistic information 35.

The information processing apparatus generates "m" that is the number of pieces of the input image data 21-1 to 21-m stored in the training data table 50 as counter information 40. Moreover, in the course of the process of performing the above described training, the information processing apparatus may generate the counter information 40 by counting up the value of the counter information every time the input image data is input to the encoder 5e₁₋₁.

Also, regarding the other cells 5₁₋₂ to 5₁₋₆₄ that are disposed in the first stage, the information processing apparatus trains the encoder and the decoder by performing the training corresponding to the training of the cell 5₁₋₁. The information processing apparatus registers the statistic information and the counter value that are generated in the initial training in a management table 70 included in the storage unit, in an associated manner with the cell 5₁₋₁ to 5₁₋₆₄ that are disposed in the first stage. A description of the management table 70 will be given with reference to FIG. 5 that will be described later.

In FIG. 3, as one example, the initial training performed on the cell 5₁₋₁ that is disposed in the first stage has been described, the information processing apparatus trains the encoder and the decoder included in the cell that is disposed in the N^{th} stage (N in this case

is an integer equal to or greater than two) in the same manner. Moreover, in the initial training performed by the information processing apparatus, regarding the input image data that is input to the encoder included in the cell that is disposed in the N^{th} stage, the feature representation that has been generated in the cell that is disposed in an N-1^{th} stage is input. The information processing apparatus performs the training on the encoder and the decoder that are included in the cell that is disposed in the N^{th} stage such that an error between the feature representation that is input to the cell disposed in the N^{th} stage and the reconstruction data that is to be output becomes small. The information processing apparatus registers, in the management table 70, the statistic information and the counter value that have been generated in the initial training and that are related to the cell that is disposed in the N^{th} stage.

For example, in the initial training, the feature representations that are input to the encoder 5e₂₋₁ that is included in the cell 5₂₋₁ that is disposed in the second stage become the feature representations 6₁₋₁ to 6₁₋₄ that are obtained from the cells 5₁₋₁ to 5₁₋₄ that are disposed in the first stage. The feature representations 6₁₋₁ to 6₁₋₄ are able to be obtained by inputting a mesh of the input image data stored in the training data table to the cells 5₁₋₂ to 5₁₋₄.

In the same way, the feature representations that are input to the encoder 5e₃₋₁ that is included in the cell 5₃₋₁ disposed in the third stage become the feature representations 6₂₋₁ to 6₂₋₄ that are obtained from the cells of 5₂₋₁ to 5₂₋₄ that are disposed in the second stage. The feature representations that are input to the encoder 5e₄₋₁ included in the cell 5₄₋₁ that is disposed in the fourth stage become the feature representations 6₃₋₁ to 6₃₋₄ that are obtained from the cells of 5₃₋₁ to 5₃₋₄ that are disposed in the third stage.

As described as above, the information processing apparatus performs the initial training on each of the cells that are included in the autoencoder 5. For example, the information processing apparatus registers, in the management table 70, the statistic information and the counter information that are associated with each of the cells and that have been generated at the time of the initial training.

FIG. 5 is a diagram illustrating one example of a data structure of the management table. As illustrated in FIG. 5, the management table 70 includes cell identification information, statistic information, and counter information. The cell identification information is information for uniquely identifying a cell. The statistic information corresponds to the statistic information 35 that has been described above with reference to FIG. 4. The statistic information is set for each cell identification information. The counter information corresponds to the counter information 40 that has been described above. The counter information is set for each cell identification information.

When the information processing apparatus ends the initial training, the information processing apparatus clears the training data table 50, and deletes the feature representations stored in the buffer 30.

In a case where the input image data including an untrained pattern appears, the information processing apparatus uses the trained autoencoder 5, and determines to perform a retraining while performing various kinds of processes.

For example, the information processing apparatus determines whether or not a retraining is to be performed for each cell included in the autoencoder 5. First, a process performed in the information processing apparatus will be described by using the cell 5₁₋₁ that is disposed in the first stage.

The information processing apparatus counts the number of times a difference between the input image data that has been input to the encoder 5e₁₋₁ and the reconstruction data that has been output from the decoder 5d₁₋₁ is equal to or greater than a threshold, and determines that a retraining is performed on the cell 5₁₋₁ in a case where the subject number of times is equal to or greater than a predetermined number of times. Furthermore, the information processing apparatus registers the input image data indicated when the difference between the input image data and the reconstruction data is equal to or greater than the threshold as the input image data including the untrained pattern in the training data table 50. In the description below, the input image data including the untrained pattern is referred to as "untrained input data". Moreover, the information processing apparatus associates the untrained input data with the cell identification information, and registers the associated data in the training data table 50.

The information processing apparatus determines whether or not the retraining is to be performed on the other cells that are disposed in the first stage by performing the same process as that performed on the cell 5₁₋₁.

Subsequently, a process performed in the information processing apparatus will be described by using the cell that is disposed in the N^{th} stage. The information processing apparatus acquires the feature representations from the cell that is disposed in the N-1^{th} stage. For example, in a case where the cell disposed in the N^{th} stage is the cell 5₂₋₁, the information processing apparatus acquires the feature representations 6₁₋₁ to 6₁₋₄. The information processing apparatus inputs the feature representations that have been acquired from the cell that is disposed in the N-1^{th} stage to the encoder that is included in the cell disposed in the N^{th} stage. In the description below, the feature representations that have been acquired from the cell disposed in the N-1^{th} stage and that have been input to the encoder that is included in the cell disposed in the N^{th} stage are appropriately referred to as an "input feature representation".

The information processing apparatus counts the number of times the difference between the input feature representation that has been input to the encoder that is included in the cell disposed in the N^{th} stage and the reconstruction data that has been output from the decoder is equal to or greater than the threshold, and determines that the retraining is performed in a case where the subject number of times is equal to or greater than the predetermined number of times. The information processing apparatus registers the input feature representation indicated when the difference between the input feature representation and the reconstruction data is equal to or greater than the threshold as the input feature representation including the untrained pattern in the training data table 50. The information processing apparatus associates the cell identification information on the cell disposed in the N^{th} stage with the input feature representation, and registers the associated information in the training data table 50.

Furthermore, the information processing apparatus also performs the following process in a case where a difference between the input feature representation and the reconstruction data in a certain cell disposed in the N^{th} stage is equal to or greater than the threshold. The information processing apparatus acquires the feature representation that is output from the encoder when the input feature representation is input to the encoder that is included in a certain cell disposed in the N^{th} stage, and specifies the certain cell that is disposed in an N+1^{th} stage that uses the subject feature representation. The information processing apparatus associates the cell identification information on the specified certain cell that is disposed in the N+1^{th} stage with the feature representation that is output from the encoder that is included in the certain cell disposed in the N^{th} stage, and then registers the associated information in the training data table 50.

In the same way as described as above, regarding the cells that are disposed in the first stage, the information processing apparatus associates the cell identification information on the corresponding cell with the untrained input data, and registers the associated information in the training data table 50 every time the difference between the input image data and the reconstruction data is equal to or greater than the threshold. Regarding the cells disposed in the N^{th} stage, the information processing apparatus associates the cell identification information on the corresponding cell with the input feature representation, and registers the associated information in the training data table 50 every time the difference between the input feature representation that has been acquired from the N-1^{th} stage and the reconstruction data is equal to or greater than the threshold. Furthermore, in a case where the difference between the input feature representation and the reconstruction data is equal to or greater than the threshold in a certain cell disposed in the N^{th} stage, the information processing apparatus associates the cell identification information on the certain cell that is disposed in the N+1^{th} stage with the feature representation that is output from the encoder included in the certain cell that is disposed in the N^{th} stage, and then registers the associated information in the training data table 50.

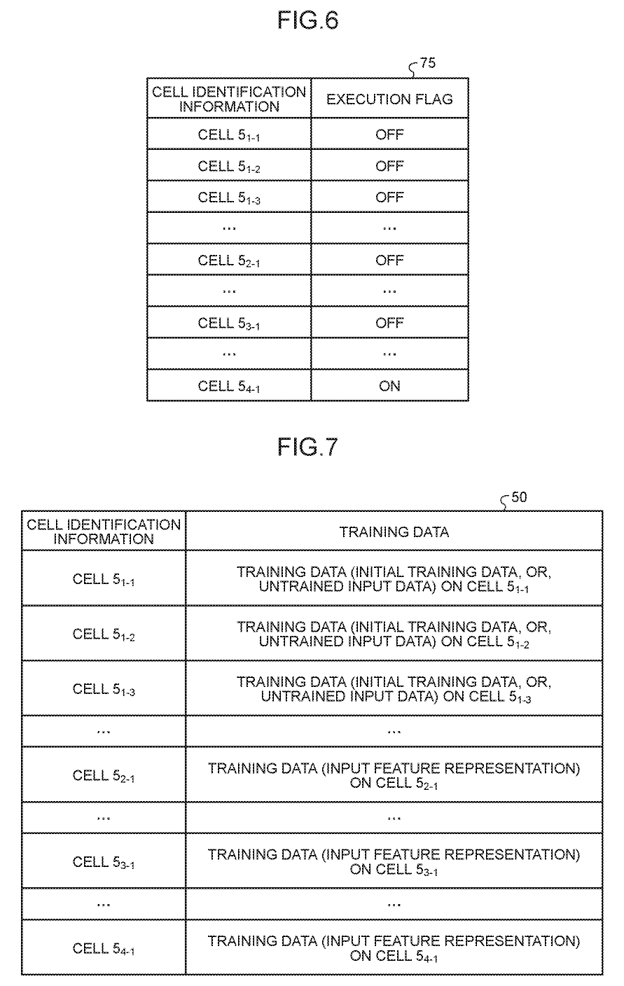

FIG. 6 is a diagram illustrating one example of a data structure of the training data table. As illustrated in FIG. 7, the training data table 50 associates the cell identification information with the training data. The cell identification information is information for uniquely identifying a cell. The training data is the training data (training data set) that is used when a cell is trained or retrained. The training data stored in the training data table 50 is deleted every time the training or the retraining has been completed.

By performing the above described process on each of the cells included in the autoencoder 5, the information processing apparatus determines whether or not a retraining is to be performed for each cell, and sets an execution flag indicating that the retraining is to be performed on the cell that is targeted for the retraining in the retraining target management table.

FIG. 7 is a diagram illustrating one example of a data structure of the retraining target management table. As illustrated in FIG. 6, a retraining target management table 80 associates the cell identification information with the execution flag. The cell identification information is information for uniquely identifying a cell. The execution flag is set to "ON" in a case where it is determined that the retraining is performed on the target cell. The execution flag is set to "OFF" in a case where it is determined that the retraining is not performed on the target cell.

After the information processing apparatus has performed the above described process in a certain period of time by using the trained autoencoder 5, the information processing apparatus determines the cell that is actually to be subjected to the retraining, on the basis of the retraining target management table 80. Moreover, the information processing apparatus may refer to the retraining target management table 80, and may specify a cell that is actually to be subjected to the retraining in a case where the number of cells in each of which the execution flag is set to "ON" is equal to or greater than a preset number.

The information processing apparatus defines, on the basis of the retraining target management table 80, the cell in which the execution flag is set to "ON" as a target for the retraining. Furthermore, the information processing apparatus also determines whether or not the cell in which the execution flag is set to "OFF" is to be a target for the retraining by performing the following process. For example, in a case where the execution flag of the cell that is disposed in the N^{th} stage is set to "ON", the information processing apparatus also defines the cell that is disposed in the N+1^{th} stage and in which the feature representation of that cell is used as the target for the retraining.

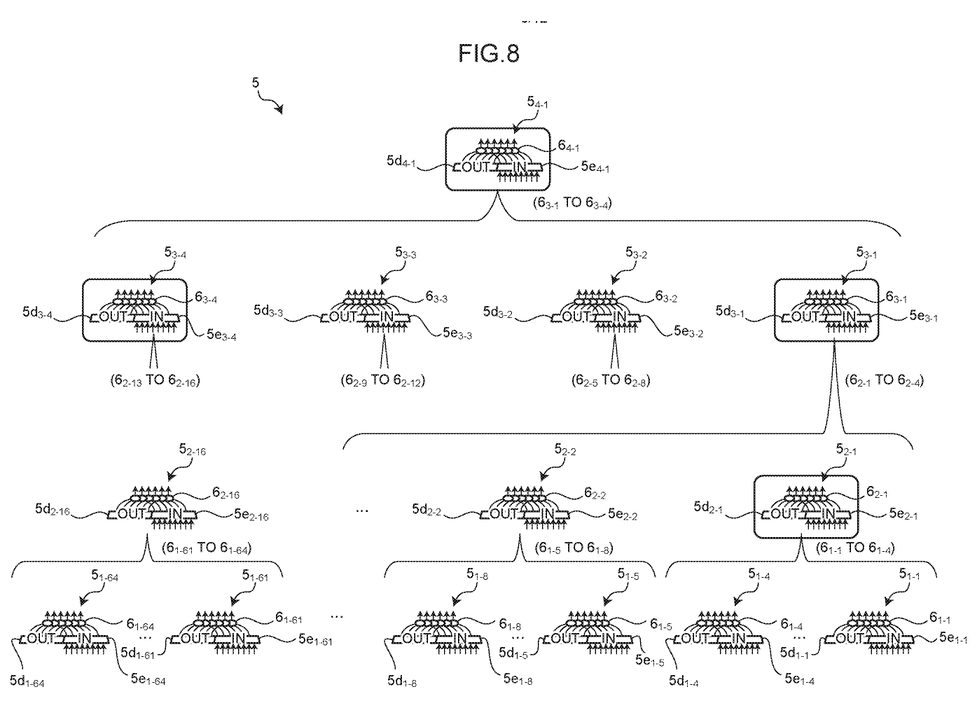

FIG. 8 is a diagram for explaining a cell targeted for a retraining. For example, it is assumed that the execution flag of each of the cells 5₂₋₁ and the cell 5₃₋₄ is set to "ON" and the execution flag of the other cells are set to "OFF". In this case, the information processing apparatus recognizes the cell 5₃₋₁ that uses the feature representation of the cell 5₂₋₁ as the input feature representation as the target for the retraining, and updates the execution flag of the cell 5₃₋₁ to "ON". Furthermore, the information processing apparatus recognizes the cell 5₄₋₁ that uses the feature representation of the cell 5₃₋₁ as the input feature representation as the target for the retraining, and updates the execution flag of the cell 5₄₋₁ to "ON". Moreover, the information processing apparatus recognizes the cell 5₄₋₁ that uses the feature representation of the cell 5₃₋₄ as the input feature representation as the target for the retraining, and updates the execution flag of the cell 5₄₋₁ to "ON" (already set to "ON" as a result of the above described processes).

By performing the above described processes, the information processing apparatus specifies the cells 5₂₋₁, 5₃₋₁, 5₃₋₄, and 5₄₋₁ as the targets for the retraining.

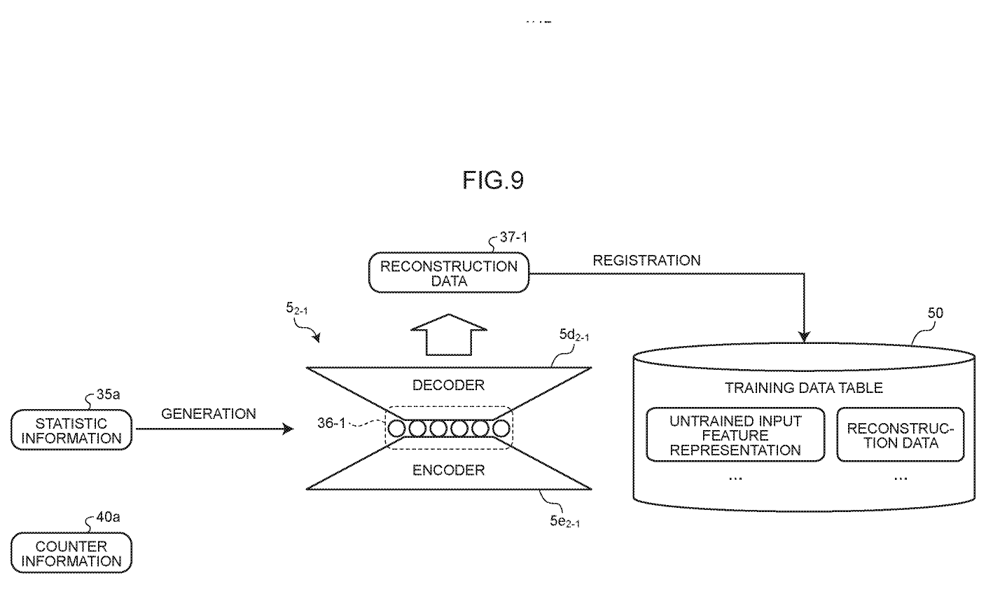

After having specified the cell corresponding to the target for the retraining, the information processing apparatus generates, for each cell targeted for the retraining, data for performing the retraining. FIG. 9 is a diagram for explaining a process of generating data that for performing the retraining. In the explanation given in FIG. 9, as one example, a process of generating the data for performing the retraining on the cell 5₂₋₁ will be described.

The information processing apparatus acquires statistic information 35a and counter information 40a that are associated with the cell 5₂₋₁ from the management table 70. The information processing apparatus generates feature representation 36-1 on the basis of the statistic information 35a.

For example, the information processing apparatus sets a value of the first element of the feature representation 36-1 by performing the following process. The information processing apparatus acquires the statistic of the first element that has been set to the statistic information 35a, sets a normal distribution based on the average and the variance that are included in the statistic, and generates a value of the first element by using random number generation following the normal distribution. As the random number generation following the normal distribution, the Box-Muller method may be used. Furthermore, the information processing apparatus may adjust a value such that the value of the first element is included in the range between the minimum value and the maximum value of the statistic. The information processing apparatus also generates the feature representation 36-1 regarding the other elements by performing the same process.

The information processing apparatus generates reconstruction data 37-1 by inputting the feature representation 36-1 to the decoder 5d₂₋₁. The information processing apparatus registers the reconstruction data in the training data table 50 as the input feature representation for performing the training. In this case, the information processing apparatus registers the input image data in the training data table 50 by associating the input image data with the cell identification information "5₂₋₁".

The information processing apparatus generates the feature representation on the basis of the statistic information 35a, and repeatedly performs the series of the processes of generating the reconstruction data for the number of times that has been set in the counter information 40a. For example, in a case where "m" has been registered in the counter information 40a, the information processing apparatus generates m pieces of reconstruction data by repeatedly performing the above described process m times, and registers the generated reconstruction data in the training data table 50. As a result of this, it is possible to generate the same input feature representation by using the statistic information 35a without storing the input feature representation that has been used at the time of the last training in the training data table 50. Moreover, in the training data table 50, in addition to the reconstruction data that is generated by the above described process, an untrained input feature representation that has been registered in the process of determining whether or not the retraining is to be performed is also included.

By also performing the above described process on the other cells corresponding to the target for the retraining, the information processing apparatus generates the data for performing the retraining, and registers the generated data in the training data table.

After having performed the process of generating the data for performing the retraining, the information processing apparatus performs the retraining for each cell that is targeted for the retraining. In a case where a plurality of cells that are subject to the training target are present, the information processing apparatus performs the retraining starting from the cells that are disposed in the lower stages. For example, as explained above with reference to FIG. 8, in a case where the information processing apparatus retrains the cells 5₂₋₁, 5₃₋₁, 5₃₋₄, and 5₄₋₁, the information processing apparatus performs the retraining on the cell 5₂₋₁, and then, performs the retraining on the cell 5₃₋₁ after having completed the retraining of the cell 5₂₋₁. The information processing apparatus performs the retraining on the cell 5₃₋₄ after having completed the retraining of the cell 5₃₋₁. The information processing apparatus performs the retraining on the cell 5₄₋₁ after having completed the retraining of the cell 5₃₋₁ and the cell 5₃₋₄. Moreover, the information processing apparatus may perform the retraining on the cells that are disposed in the same stage in any order.

One example of the retraining performed by the information processing apparatus will be described. Here, as one example, a case in which the cell 5₂₋₁ is retrained will be described. The information processing apparatus performs the retraining on the cell 5₂₋₁ by using the training data table 50, as illustrated in FIG. 9.

The retraining performed by the information processing apparatus is the same as the initial training that has been described above with reference to FIG. 3. For example, the information processing apparatus inputs the input feature representation stored in the training data table 50 to the encoder 5e₂₋₁, acquires the reconstruction data that is output from the decoder 5d₂₋₁, and updates the parameters for the encoder 5e₂₋₁ and the decoder 5d₂₋₁ such that the difference between the input feature representation and the reconstruction data becomes small. Furthermore, the information processing apparatus stores the feature representation that is generated when the input feature representation is input to the encoder 5e₂₋₁ in the buffer 30, calculates the statistic of each of the elements, and updates the statistic information.

The information processing apparatus also updates the counter information. For example, in a case where both of m pieces of reconstruction data and a one piece of untrained input data (untrained input feature representation) are registered in the training data table 50, the value that is set in the counter information is "m + l".

The information processing apparatus also repeatedly performs the above described process on the other cells that are targeted for the retraining. When the above described retraining has been ended, the information processing apparatus clears the training data table 50 , and deletes the feature representations that has been stored in the buffer 30. The information processing apparatus determines to perform the retraining in a case where the input image data including the untrained pattern appears while performing the various kinds of processes by using the trained autoencoder 10. In a case where the information processing apparatus determines to perform the retraining, the information processing apparatus again performs the above described process.

As described above, the information processing apparatus according to the present embodiment specifies the cell in which the difference between the input data and the output data is equal to or greater than a predetermined standard from among the cells that are included in the autoencoder 5. Furthermore, the information processing apparatus performs the retraining on the autoencoder 5 by using, as the target for the training , both of the specified cell and the cell that is located at a higher level and that uses the output data that has been output from the specified cell as the input data. As a result of this, it is possible to reduce the cost needed for the retraining at the time of the retraining. For example, it is possible to use some of the cells as the target for the retraining, so that it is possible to reduce the time and the electrical power needed for the retraining.

The information processing apparatus generates the feature representation on the basis of the statistic information at the time of the retraining, and inputs the feature representation to the decoder, so that the information processing apparatus generates the reconstruction data, and registers the obtained reconstruction data in the training data table 50. It can be said that the reconstruction data that has been registered in the training data table 50 corresponds to the input data that has been used in the last training. In other words, the information processing apparatus is able to train the autoencoder 5 without storing the already-existing input data. Furthermore, it is also possible to suppress an occurrence of catastrophic forgetting.

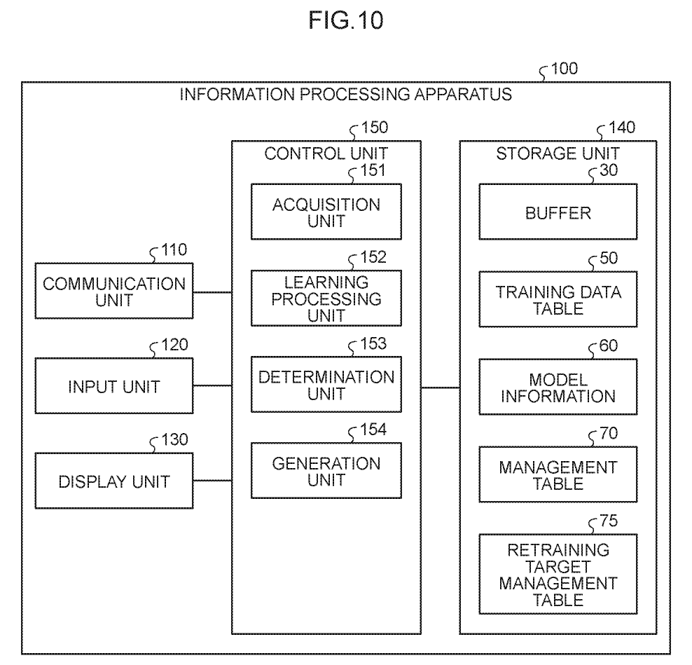

In the following, an example of a configuration of the information processing apparatus that performs the processes described above with reference to FIG. 1 to FIG. 9 will be described. FIG. 10 is a functional block diagram illustrating a configuration of the information processing apparatus according to the present embodiment. As illustrated in FIG. 10, an information processing apparatus 100 includes a communication unit 110, an input unit 120, a display unit 130, a storage unit 140, and a control unit 150.

The communication unit 110 performs data communication with an external device or the like via a network. The communication unit 110 is a network interface card (NIC), or the like. For example, the communication unit 110 acquires, from the external device, input image data or the like that is used when a training is performed first time.

The input unit 120 is an input device for inputting various kinds of information to the control unit 150 included in the information processing apparatus 100. For example, the input unit 120 corresponds to a keyboard, a mouse, a touch panel, or the like. A user may instruct to perform the initial training by operating the operate the input unit 120.

The display unit 130 is a display device for displaying information that is output from the control unit 150.

The storage unit 140 includes the buffer 30, the training data table 50, a model information 60, the management table 70, and a retraining target management table 75. The storage unit 140 is a storage device, such as a memory.

The buffer 30 temporarily stores therein a feature representation that is output from an encoder when each of the cells included in the autoencoder 5 is train ed. The feature representation corresponds to an "output value".

In the training data table 50, the data for training each of the cells included in the autoencoder 5 is stored. For example, regarding the initial training, the pieces of input image data 21-1 to 21-m that are prepared in advance are stored. Moreover, after the initial training has been completed, the pieces of input image data 21-1 to 21-m stored in the training data table 50 are deleted.

Furthermore, after the initial training has been completed, in the training data table 50, untrained input data and an untrained input feature representation are stored. Furthermore, in the training data table 50, the reconstruction data that has been generated by the process described above with reference to FIG. 9 is stored. The data stored in the training data table 50 is deleted every time a training is completed. The data structure of the training data table 50 corresponds to the data structure described above with reference to FIG. 7.

The model information 60 holds the information related to the autoencoder 5 described above with reference to FIG. 1. The autoencoder 5 includes the plurality of cells, and each of the cells includes the encoder and the decoder. The encoder generates the feature representation by encoding the input data. The decoder generates the reconstruction data on the basis of the feature representation obtained by the encoder. The dimension of the input data and the reconstruction data is an N dimension. The dimension of the feature representation is an n dimension (N > n). Each of the cells included in the autoencoder 5 corresponds to the "autoencoder".

The management table 70 holds the statistic information and counter information for each cell that is generated at the time of the training. The description of the management table 70 is the same as that related to the management table 70 described above with reference to FIG. 5.

The retraining target management table 75 holds the information related to the cell that is targeted for the retraining. The description of the retraining target management table 75 is the same as that related to the retraining target management table 75 described above with reference to FIG. 6.

The control unit 150 includes an acquisition unit 151, a learning processing unit 152, a determination unit 153, and a generation unit 154. The control unit 150 is a central processing unit (CPU), a graphics processing unit (GPU), or the like.

The acquisition unit 151 acquires various kinds of information from the external device, or the like via the communication unit 110. For example, the acquisition unit 151 acquires the input image data that is used when the training is initially performed from the external device, and stores the acquired input image data in the training data table 50.

The learning processing unit 152 uses the training data table 50, and trains (retrains) each of the cells that are included in the autoencoder 5. The learning processing unit 152 sequentially performs the training from the cell that is disposed in the bottom stage in the initial training performed on the autoencoder 5. For example, the learning processing unit 152 performs the initial training on each of the cells 5₁₋₁ to 5₁₋₆₄ that are disposed in the first stage, and then, after having completed the initial training of each of the cells 5₁₋₁ to 5₁₋₆₄, the learning processing unit 152 proceeds to the initial training of the cells 5₂₋₁ to 5₂₋₁₆ that are disposed in the second stage. After having completed the initial training of each of the cells 5₂₋₁ to 5₂₋₁₆ that are disposed in the second stage, the learning processing unit 152 proceeds to the initial training of each of the cells 5₃₋₁ to 5₃₋₄ that are disposed in the third stage. After having completed the initial training of each of the cells 5₃₋₁ to 5₃₋₄ that are disposed in the third stage, the learning processing unit 152 proceeds to the initial training of the cell 5₄₋₁ that is disposed in the fourth stage. In a case where the learning processing unit 152 has completed the initial training of the cell 5₄₋₁ that is disposed in the fourth stage, the learning processing unit 152 determines that the initial training to be performed on the autoencoder 5 has been completed.

The initial training that is performed on each of the cells by the learning processing unit 152 is the same as that described above with reference to FIG. 3. In other words, the learning processing unit 152 generates the feature representation by inputting the input data to the encoder related to each of the cells. As described above, the input data that is input to the encoder included in the cell that is disposed in the first stage corresponds to the data obtained by dividing the input image data into a mesh. The input data that is input to the encoder included in the cell that is disposed in the N^{th} stage corresponds to the feature representation that is generated by the cell disposed in the N-1^{th} stage. The learning processing unit 152 generates the reconstruction data by inputting the feature representation to the decoder. The learning processing unit 152 trains the encoder and the decoder such that the error between the input data and the reconstruction data becomes small.

Regarding the training (retraining) performed after the second training (retraining) and the subsequent trainings (retrainings) performed by the learning processing unit 152, the cell targeted for the training target corresponds to some of the cells. For example, the learning processing unit 152 refers to the retraining target management table 75, and performs the retraining on the cell in which the execution flag is set to "ON" as the target. The content of the retraining itself performed by the learning processing unit 152 is the same as that of the initial training.

Moreover, in the course of the process of performing the training (retraining), the learning processing unit 152 generates the statistic information and the counter information for each cell, and registers the statistic information and the counter information in the management table 70. In a case where the statistic information and the counter information that have been generated at the previous training are registered in the management table 70, the learning processing unit 152 updates the registered statistic information and the counter information to the statistic information and the counter information that are generated this time.

When the learning processing unit 152 ends the training (retraining) performed with respect to the autoencoder 5 , the learning processing unit 152 clears the training data table 50, and then deletes the feature representation that has been stored in the buffer 30. The descriptions of the other processes related to the learning processing unit 152 are the same as those described above with reference to FIG. 2, FIG. 3, and the like.

In a case where the learning processing unit 152 receives an instruction to perform the initial training from the input unit 120, the learning processing unit 152 performs the initial training with respect to the autoencoder 5. In a case where the learning processing unit 152 receives a request to perform the retraining from the determination unit 153 that will be described later, the learning processing unit 152 performs the retraining with respect to the autoencoder 5.

The determination unit 153 newly acquires a plurality of pieces of input image data corresponding to the processing targets from the external device, or the like via the communication unit 110, and determines whether or not the retraining is to be performed on each of the cells included in the trained autoencoder 5 by using a plurality of pieces of input image data. The determination unit 153 may also acquire the pieces of input image data via the acquisition unit 151.

A process performed by the determination unit 153 will be described by using the cell 5₁₋₁ that is disposed in the first stage. The determination unit 153 counts the number of times the difference between the input image data that has been input to the encoder 5e₁₋₁ and the reconstruction data that has been output from the decoder 5d₁₋₁ is equal to or greater than the threshold, and determines, in a case where the subject number of times is equal to or greater than the predetermined number of times, that the retraining is performed on the cell 5₁₋₁. Furthermore, the determination unit 153 registers the untrained input data indicated when the difference between the input image data and the reconstruction data is equal to or greater than the threshold in the training data table 50.

Subsequently, the process performed by the determination unit 153 will be described by using the cell that is disposed in the N^{th} stage. The determination unit 153 acquires the feature representation from the cell that is disposed in the N-1^{th} stage. For example, in a case where the cell disposed in the N^{th} stage is the cell 5₂₋₁, the determination unit 153 acquires the feature representations 6₁₋₁ to 6₁₋₄. The determination unit 153 inputs the input feature representation that has been acquired from the cell that is disposed in the N-1^{th} stage to the encoder that is included in the cell disposed in the N^{th} stage.

The determination unit 153 counts the number of times the difference between the input feature representation that has been input to the encoder included in the cell that is disposed in the N^{th} stage and the reconstruction data that has been output from the decoder is equal to or greater than the threshold, and determines to perform the retraining in a case where the counted number of times is equal to or greater than the predetermined number of times. The determination unit 153 registers the input feature representation indicated when the difference between the input feature representation and the reconstruction data is equal to or greater than the threshold in the training data table 50 as the input feature representation including the untrained pattern. The determination unit 153 associates the cell identification information on the cell that is disposed in the N^{th} stage with the input feature representation, and registers the associated data in the training data table 50.

Furthermore, the determination unit 153 also performs the following process in a case where the difference between the input feature representation and the reconstruction data is equal to or greater than the threshold in a certain cell that is disposed in the N^{th} stage. The determination unit 153 acquires the feature representation that is output from the encoder when the input feature representation is input to the encoder that is included in the certain cell disposed in the N^{th} stage, and specifies the certain cell that is disposed in the N+1^{th} stage and that uses the subject feature representation. The determination unit 153 associates the cell identification information on the specified certain cell that is disposed in the N+1^{th} stage with the feature representation that is output from the encoder that is included in the certain cell disposed in the N^{th} stage, and registers the associated data in the training data table 50.

The determination unit 153 determines, for each cell, whether or not the retraining is to be performed by performing the above described processes on each of the cells that are included in the autoencoder 5, and sets the execution flag corresponding to the cell identification information on the cell targeted for the retraining to "ON".

After the determination unit 153 has performed the above described process in a certain period of time by using the trained autoencoder 5, the determination unit 153 determines the cell that is actually to be subjected to the retraining, on the basis of the retraining target management table 80 . The determination unit 153 determines the cell in which the execution flag is set to "ON" is the target for the retraining, on the basis of the retraining target management table 80. Furthermore, also, regarding the cell in which the execution flag is set to "OFF", the determination unit 153 determines whether or not the cell is to be subjected to the retraining by performing the following process. For example, in a case where the execution flag of the cell disposed in the N^{th} stage is set to "ON", the determination unit 153 also determines that the cell that is disposed in the N+1^{th} stage that uses the feature representation of the subject cell is the target for the retraining, and updates the execution flag of the subject cell to "ON".

After the above described processes have been completed, in a case where at least one of cells that are included in the retraining target management table and in which the execution flag is set to "ON" is present, the determination unit 153 determines to perform the retraining, and outputs a request to perform the retraining to the learning processing unit 152. Furthermore, in a case where the determination unit 153 determines to perform the retraining, the determination unit 153 outputs a request to generate the data to the generation unit 154.

In a case where the generation unit 154 receives the request to generate the data, the generation unit 154 refers to the retraining target management table 75, and specifies the cell that is targeted for the retraining. The generation unit 154 acquires the statistic information and the counter information that are associated with the specified cell. The generation unit 154 generates a plurality of feature representations on the basis of the statistic information. The generation unit 154 generates a plurality of pieces of reconstruction data from the plurality of feature representations, and registers the plurality of pieces of reconstruction data as the data that is used at the time of the training in the training data table 50.

For example, the generation unit 154 sets the value of the first element of the feature representation by performing the following process. The generation unit 154 acquires the statistic of the first element that has been set to the statistic information, sets the normal distribution based on the average and the variance that are included in the statistic, and generates the value of the first element by using the random number generation following the normal distribution. As the random number generation following the normal distribution, the Box-Muller method may be used. Furthermore, the generation unit 154 may adjust a value such that the value of the first element is included in the range between the minimum value and the maximum value of the statistic. The generation unit 154 also generates the feature representation regarding the other elements by performing the same process.

The generation unit 154 generates the feature representation on the basis of the statistic information, repeatedly performs the series of the processes of generating the reconstruction data for the number of times that has been set in the counter information, and stores each of the pieces of reconstruction data in the training data table 50. The process performed by the generation unit 154 corresponds to the process described above with reference to FIG. 9. The generation unit 154 generates each of the pieces of reconstruction data of the cell that is targeted for the retraining, and stores the generated data in the training data table 50.

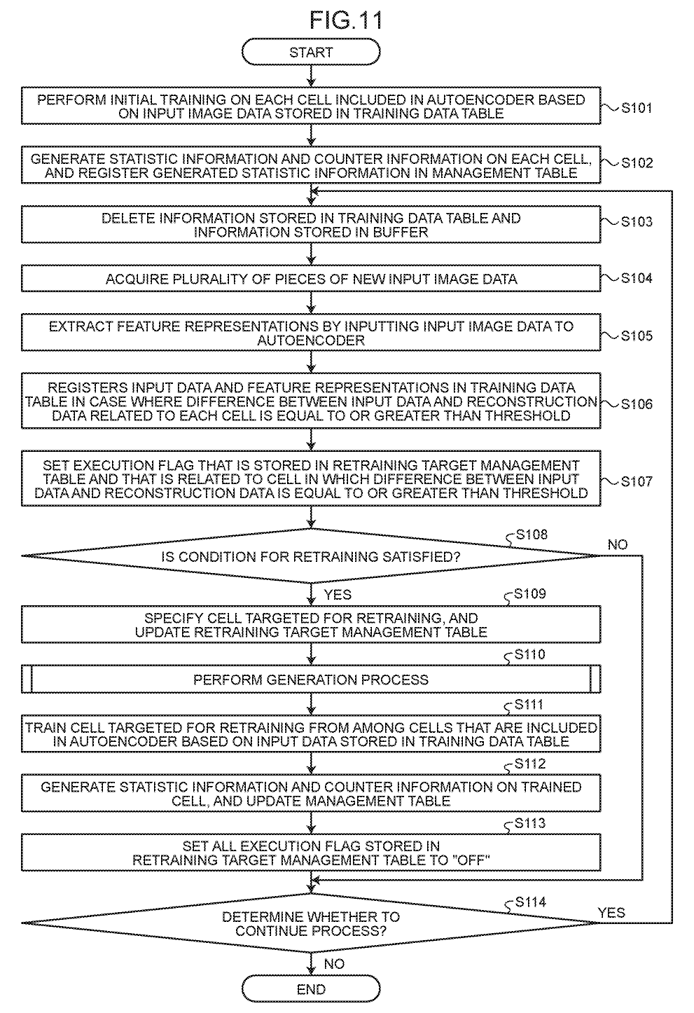

In the following, one example of the flow of a process performed in the information processing apparatus 100 according to the present embodiment will be described. FIG. 11 is a flowchart illustrating the flow of a process performed in the information processing apparatus according to the present embodiment. In FIG. 11, for convenience of description, the pieces of data that are input to the respective encoders that are included in the respective cells included in the autoencoder are collectively referred to as input data.

As illustrated in FIG. 11, the learning processing unit 152 included in the information processing apparatus 100 performs the initial training on each of the cells that are included in the autoencoder 5 on the basis of the input image data stored in the training data table 50 (Step S101).

The learning processing unit 152 generates the statistic information and the counter information on each of the cells, and registers the generated statistic information in the management table 70 (Step S102). The learning processing unit 152 deletes both of the information stored in the training data table 50 and the information stored in the buffer 30 (Step S103).

The acquisition unit 151 included in the information processing apparatus 100 acquires the plurality of pieces of new input image data from the external device, or the like (Step S104). The determination unit 153 included in the information processing apparatus 100 extracts feature representations by inputting the input image data to the autoencoder 5 (Step S105).

The determination unit 153 registers both of the input data and the feature representations in the training data table 50 in a case where the difference between the input data and the reconstruction data related to each of the cells is equal to or greater than the threshold (Step S106). The determination unit 153 sets the execution flag that is stored in the retraining target management table 75 and that is related to the cell in which the difference between the input data and the reconstruction data is equal to or greater than the threshold (Step S107).

The determination unit 153 determines whether or not a condition for the retraining is satisfied (Step S108). For example, the determination unit 153 may determine that the condition for the retraining is satisfied in a case where the number of cells indicated to be "ON" from among the execution flags stored in the retraining target management table 75 is equal to or greater than the predetermined number.

In a case where the condition for the retraining is not satisfied (No at Step S108), the determination unit 153 proceeds to Step S114. In contrast, in a case where the condition for the retraining is satisfied (Yes at Step S108), the determination unit 153 proceeds to Step S109.

The determination unit 153 specifies the cell targeted for the retraining, and updates the retraining target management table 75 (Step S109). The generation unit 154 included in the information processing apparatus 100 performs the generation process (Step S110).

The learning processing unit 152 trains the cell targeted for the retraining from among the cells that are included in the autoencoder 5 on the basis of the input data stored in the training data table 50 (Step S111). The learning processing unit 152 generates the statistic information and the counter information on the trained cell, and updates the management table (Step S112). The learning processing unit 152 sets all of the execution flag stored in the retraining target management table to "OFF" (Step S113).

In a case where the information processing apparatus 100 continues the process (Yes at Step S114), the information processing apparatus 100 proceeds to Step S103. In contrast, in a case where the information processing apparatus 100 does not continue the process (No at Step S114), the information processing apparatus 100 ends the process.

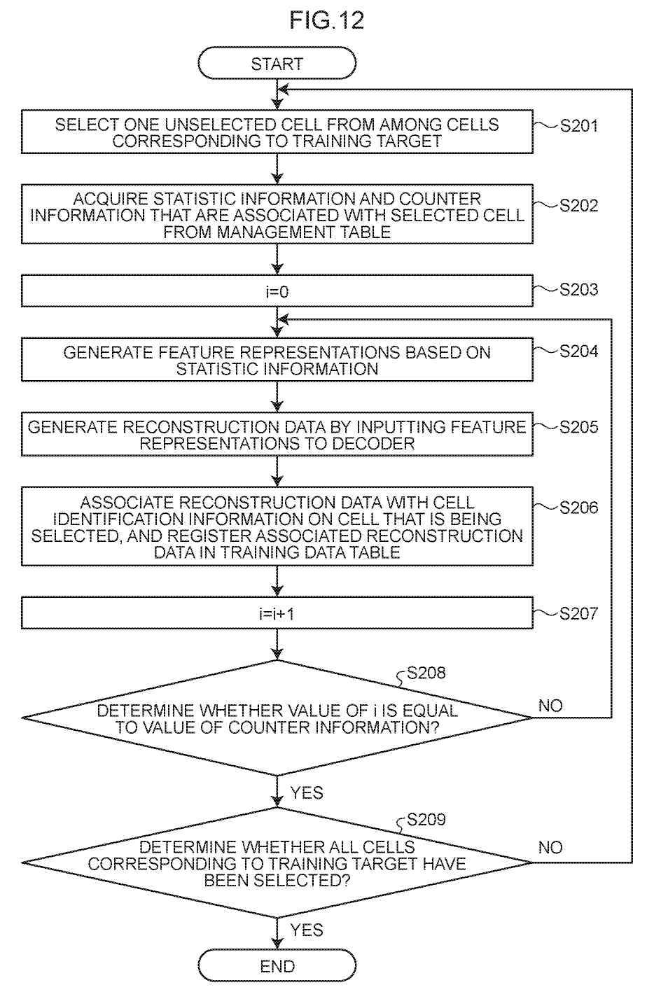

In the following, one example of the generation process that has been described above at Step S110 illustrated in FIG. 11 will be described. FIG. 12 is a flowchart illustrating the flow of the generation process. As illustrated in FIG. 12, the generation unit 154 included in the information processing apparatus 100 selects one cell that has not been selected from among the cells that corresponds to the training target (Step S201). The information processing apparatus 100 acquires the statistic information and the counter information that are associated with the selected cell from the management table (Step S202).

The generation unit 154 sets i = 0 (Step S203). The generation unit 154 generates the feature representations on the basis of the statistic information (Step S204). The generation unit 154 generates the reconstruction data by inputting the feature representations to the decoder (Step S205).

The generation unit 154 associates the reconstruction data with the cell identification information on the cell that is being selected, and registers the associated reconstruction data in the training data table 50 (Step S206). The generation unit 154 sets i = i + 1 (Step S207).

In a case where the value of i is not equal to the value of the counter information (No at Step S208), the generation unit 154 proceeds to Step S204. In a case where the value of i is equal to the value of the counter information (Yes at Step S208), the generation unit 154 proceeds to Step S209.

In a case where the generation unit 154 has not selected all of the cells corresponding to the training target (No at Step S209), the generation unit 154 proceeds to Step S201 . In contrast, in a case where the generation unit 154 has selected all of the cells corresponding to the training target (Yes at Step S209), the generation unit 154 ends the process.

In the following, the effects of the information processing apparatus 100 according to the present embodiment will be described. The information processing apparatus 100 specifies the cell in which a difference between the input data and the output data is equal to or greater than the predetermined standard from among the cells included in the autoencoder 5. Furthermore, the information processing apparatus 100 performs the retraining on the autoencoder 5 by using, as the target for the training, both of the specified cell and the cell that is located at a higher level and that uses the output data that has been output from the specified cell as the input data. As a result of this, it is possible to reduce the cost needed for the retraining at the time of the retraining. For example, it is possible to use some of the cells as the target for the retraining, so that it is possible to reduce the time and the electrical power needed for the retraining.

The information processing apparatus 100 generates a feature representation on the basis of the statistic information at the time of the retraining, and inputs the feature representation to the decoder, so that the information processing apparatus generates the reconstruction data, and registers the obtained reconstruction data in the training data table 50. It can be said that the reconstruction data that has been registered in the training data table 50 corresponds to the input data that has been used in the last training. In other words, the information processing apparatus 100 is able to train the cell corresponding to the training target included in the autoencoder 5 without storing the already-existing input data. Furthermore, it is also possible to suppress an occurrence of catastrophic forgetting.

The information processing apparatus 100 generates the plurality of feature representations by inputting each of the pieces of input image data registered in the training data table 50 to the encoder, and generates the statistic information on the basis of the plurality of feature representations. As a result of this, the information processing apparatus 100 is able to extract the statistic of the input image data stored in the training data table 50.

By performing the process of generating the reconstruction data using the statistic information the number of times that has been set in the counter information, the information processing apparatus 100 is able to register, in the training data table 50 , the pieces of data each of which corresponds to the input data that is used at the previous training by an amount equal to the pieces of input data that are used at the previous training.

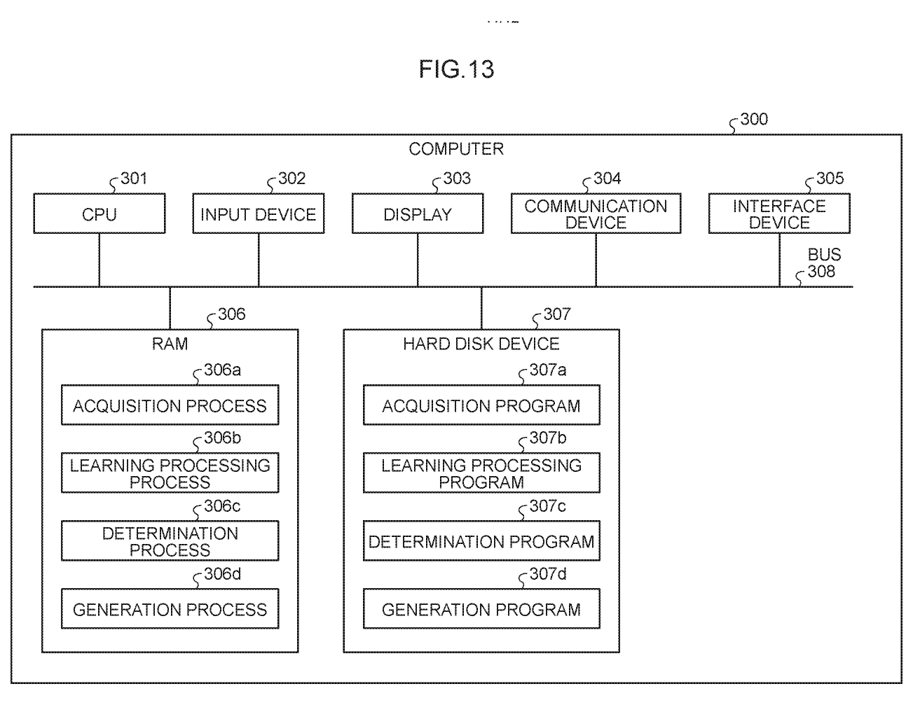

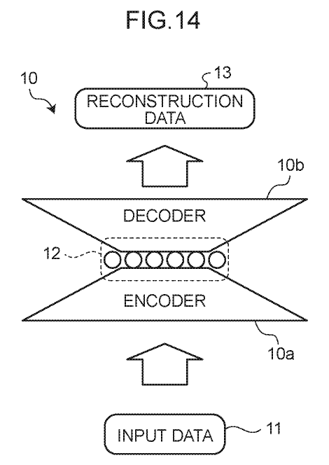

In the following, one example of a configuration of a hardware of a computer that implements the same function as that of the above described information processing apparatus 100 will be described. FIG. 13 is a diagram illustrating one example of the configuration of the hardware of the computer that implements the same function as that of the information processing apparatus according to the present embodiment.

As illustrated in FIG. 13, a computer 300 includes a CPU 301 that executes various kinds arithmetic processing, an input device 302 that receives an input of data from a user, and a display 303. Furthermore, the computer 300 includes a communication device 304 that sends and receives data to and from an external device or the like via a wired or wireless network, and an interface device 305. Furthermore, the computer 300 includes a RAM 306 that temporarily stores therein various kinds of information, and a hard disk device 307. In addition, each of the devices 301 to 307 is connected to a bus 308.

The hard disk device 307 includes an acquisition program 307a, a learning processing program 307b, a determination program 307c, and a generation program 307d. The CPU 301 reads each of the programs 307a to 307d and loads the programs into the RAM 306.

The acquisition program 307a functions as an acquisition process 306a. The learning processing program 307b functions as a learning processing process 306b. The determination program 307c functions a determination process 306c. The generation program 307d functions as a generation process 306d.

The process of the acquisition process 306a corresponds to the process performed by the acquisition unit 151. The process of the learning processing process 306b corresponds to the process performed by the learning processing unit 152. The process of the determination process 306c corresponds to the process performed by the determination unit 153. The process of the generation process 306d corresponds to the process performed by the generation unit 154.

Moreover, each of the programs 307a to 307d does not need to be stored in the hard disk device 307 from the beginning. For example, each of the programs is stored in a "portable physical medium", such as a flexible disk (FD), a CD-ROM, a DVD disk, a magneto-optic disk, an IC card, that is to be inserted into the computer 300. Then, the computer 300 may read each of the programs 307a to 307d from the portable physical medium and execute the programs.

It is possible to reduce a cost needed for a retraining.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A non-transitory computer-readable recording medium having stored therein a machine learning program that causes a computer to execute a process comprising:
specifying an autoencoder in which a difference between input data and output data is equal to or greater than a predetermined standard from among autoencoders that are included in a data generation model, in a case where a training is performed on the data generation model that includes a plurality of autoencoders that are disposed in a first stage and that respectively uses a plurality of pieces of divided data obtained by dividing original input data as respective pieces of input data, and one or more autoencoders that are disposed in an N^{th} stage and that respectively use output data that has been output from each of two or more autoencoders that are disposed in an N-1^{th} from among the plurality of autoencoders that are disposed in the N-1^{th} stage (N is an integer equal to or greater than two) as input data; and
performing the training on the data generation model by using
the specified autoencoder, and
the autoencoder that receives, as the input data, the output data that has been output from the specified autoencoder
as a target for the training.

2. The non-transitory computer-readable recording medium according to claim 1, wherein
each of the autoencoders included in the data generation model includes an encoder and a decoder, and
the process further includes
acquiring a plurality of output values that are output from the respective encoders by inputting the plurality of pieces of input data to the respective encoders included in the respective autoencoders,
generating statistic information related to each of the autoencoders based on the plurality of output values, and
generating the input data for the autoencoder that is targeted for the training based on the statistic information related to the autoencoder that is targeted for the training.

3. The non-transitory computer-readable recording medium according to claim 2, wherein the process further includes
generating a value based on the statistic information, and
generating the input data for the autoencoder that is targeted for the training by inputting the generated value to the decoder.

4. The non-transitory computer-readable recording medium according to claim 2, wherein the process further includes counting, when the autoencoders are trained, the number of pieces of input data that have been input to the autoencoders, wherein
the generating the input data includes generating the same number of pieces of input data as the counted number.

5. A machine learning method comprising:
specifying an autoencoder in which a difference between input data and output data is equal to or greater than a predetermined standard from among autoencoders that are included in a data generation model by a processor, in a case where a training is performed on the data generation model that includes a plurality of autoencoders that are disposed in a first stage and that respectively uses a plurality of pieces of divided data obtained by dividing original input data as respective pieces of input data, and one or more autoencoders that are disposed in an N^{th} stage and that respectively use output data that has been output from each of two or more autoencoders that are disposed in an N-1^{th} from among the plurality of autoencoders that are disposed in the N-1^{th} stage (N is an integer equal to or greater than two) as input data; and
performing the training on the data generation model by using
the specified autoencoder, and
the autoencoder that receives, as the input data, the output data that has been output from the specified autoencoder
as a target for the training.

6. The machine learning method according to claim 5, wherein
each of the autoencoders included in the data generation model includes an encoder and a decoder, and
the machine learning method further includes
acquiring a plurality of output values that are output from the respective encoders by inputting the plurality of pieces of input data to the respective encoders included in the respective autoencoders,
generating statistic information related to each of the autoencoders based on the plurality of output values, and
generating the input data for the autoencoder that is targeted for the training based on the statistic information related to the autoencoder that is targeted for the training.

7. The machine learning method according to claim 6, further including
generating a value based on the statistic information, and
generating the input data for the autoencoder that is targeted for the training by inputting the generated value to the decoder.

8. The machine learning method according to claim 6, further including counting, when the autoencoders are trained, the number of pieces of input data that have been input to the autoencoders, wherein
the generating the input data includes generating the same number of pieces of input data as the counted number.

9. An information processing apparatus comprising:
a memory; and
a processor coupled to the memory and configured to:
specify an autoencoder in which a difference between input data and output data is equal to or greater than a predetermined standard from among autoencoders that are included in a data generation model, in a case where a training is performed on the data generation model that includes a plurality of autoencoders that are disposed in a first stage and that respectively uses a plurality of pieces of divided data obtained by dividing original input data as respective pieces of input data, and one or more autoencoders that are disposed in an N^{th} stage and that respectively use output data that has been output from each of two or more autoencoders that are disposed in an N-1^{th} from among the plurality of autoencoders that are disposed in the N-1^{th} stage (N is an integer equal to or greater than two) as input data; and
perform the training on the data generation model by using
the specified autoencoder, and
the autoencoder that receives, as the input data, the output data that has been output from the specified autoencoder
as a target for the training.

10. The information processing apparatus according to claim 9, wherein
each of the autoencoders included in the data generation model includes an encoder and a decoder, and
the processor is further configured to
acquire a plurality of output values that are output from the respective encoders by inputting the plurality of pieces of input data to the respective encoders included in the respective autoencoders,
generate statistic information related to each of the autoencoders based on the plurality of output values, and
generate the input data for the autoencoder that is targeted for the training based on the statistic information related to the autoencoder that is targeted for the training.

11. The information processing apparatus according to claim 10, wherein the processor is further configured to
generate a value based on the statistic information, and
generate the input data for the autoencoder that is targeted for the training by inputting the generated value to the decoder.

12. The information processing apparatus according to claim 10, wherein the processor is further configured to count, when the autoencoders are trained, the number of pieces of input data that have been input to the autoencoders, and
generate the same number of pieces of input data as the counted number.
